(19) United States
(12) Patent Application Publication
(10) Pub. No.: US 2018/0303202 A1
(43) Pub. Date: Oct. 25, 2018

(54) METHOD FOR MAKING A VAMP IN A TWO DIMENSIONAL MANNER AND THE VAMP MADE BY THE METHOD

(71) Applicant: DAH LIH PUH CO., LTD., TAICHUNG CITY (TW)

(72) Inventor: Jui-Fen SHIAO, TAICHUNG CITY (TW)

(73) Assignee: DAH LIH PUH CO., LTD.

(21) Appl. No.: 15/496,867

(22) Filed: Apr. 25, 2017

(51) Int. Cl. A43B 23/02; B29D 35/14

(52) U.S. Cl. CPC A43B 23/026; B29D 35/146; A43B 23/0255; A43B 23/02; A43B 23/0235; B29D 35/148

(57) ABSTRACT

A method for making a vamp in a two dimensional manner and the vamp made by the method, wherein the vamp includes a base fabric layer and an adhesive layer. The adhesive layer is firstly laid on one side of the base fabric layer, and then melted and permeated into the intervals of the base fabric layer after being heated and pressed, so that the adhesive layer and the base fabric layer are simultaneously become a three dimensional structure to form the vamp with decorative portions, thus improving the quality of the vamp, reducing the manufacturing cost, reinforcing the structural strength and improving wearing comfort.

### BACKGROUND

### Field of the Invention

The present invention relates to a shoe, and more particularly to a vamp made in a two dimensional manner.

### Related Prior Art

A shoe can be an integrally formed one-piece member or can be made up of a plurality of members. The shoe made up of a plurality of members generally includes: a vamp and a sole. The vamp can be designed to have various logos or three dimensional patterns.

A conventional vamp in a two dimensional manner is shown in FIG. 1, wherein a plurality of decorative portions X is provided on the surface of the vamp, and there are many methods for making the decorative portions X which are in the form of 3D patterns. However, each method has its own disadvantages, the details of which are described as follows:

One of the methods is shown in FIG. 2, wherein the vamp which is shown in cross section includes a base fabric 80 consisting of a plurality of fibers 81, and for easy explanation, only a part of the fibers 81 is shown. One side of the fibers 81 is coated with an adhesive layer 82, and then a decorative member 83 is glued to the base fabric 80 by the adhesive layer 82. With this method, the decorative member 83 must be formed in advance prior to being glued to the base fabric 80, which makes the manufacturing process complicated and increases the cost. In order to overcome the above disadvantages, the following two improved methods have been developed.

One of the methods is shown in FIGS. 3-1 and 3-2, wherein the base fabric 80 is woven by filament 811 and TPU (thermoplastic polyurethane) fiber 812, and the proportion of the filament 811 to the TPU fiber 812 can be adjusted as desired. During the process of forming the 3D decorative portion X, as shown in FIG. 3-1, a male die 90 and a female die 91 are disposed at two sides of the base fabric 80, then the base fabric 80 is heated to a predetermined temperature, and then the base fabric 80 is pressed to have the 3D shape of the male die 90 and the female die 91. Due to the property of the TPU material, the base fabric 80 will be solidified instantly after cooling off. However, during the course of manufacturing, the TPU fiber 812 will be broken and melted due to high temperature and high pressure, as shown in FIG. 3-2, which results in intervals M between the filaments 811, consequently reduces the strength of the base fabric 80. Besides, when the proportion of the TPU fiber 812 is low, it will cause incomplete forming, and result in hollow sections S, consequently result in low yield. Even worse, when there are intervals M between the fibers of the base fabric 80, the melted TPU will permeate to another side of the base fabric 80 contacting the wearer's skin, and once the TPU is solidified, it will make the user's foot feel uncomfortable. Besides, the manufacturing process of this method is also complicated since the TPU must be subjected to fiber spinning prior to being woven with the filament 811.

Another method is shown in FIGS. 4-1 and 4-2, wherein the base fabric 80 is also woven by two different materials, one is the filament 811, and the other is a composite filament 813. The composite filament 813 is made by prepregging the filament 811 to coat the filament 811 with a TPU layer 813A. During the process of prepregging, the TPU layer 813A will be broken and melted due to high temperature and high pressure, as shown in FIG. 4-2, which results in intervals M between the filaments, consequently reduces the strength of the base fabric 80. Besides, when the proportion of the composite filament 813 is low, it will cause incomplete forming, and result in hollow sections S, consequently result in low yield. Even worse, when there are intervals M between the fibers of the base fabric 80, the melted TPU will permeate to another side of the base fabric 80 contacting the wearer's skin, and once the TPU is solidified, it will make the user's foot feel uncomfortable. Besides, the manufacturing process of this method is also complicated since the filament 811 must be prepregged to form the TPU containing composite filament 813 prior to being woven with the filament 811.

In order to overcome the afore-described disadvantages of low strength of the base fabric, complicated manufacturing process, high manufacturing cost, low yield and uncomfortable wearing, the present invention provides a method for making a vamp in a two dimensional manner and the vamp made by it.

### SUMMARY

One objective of the present invention is to provide a vamp which is made in a two dimensional manner and capable of overcoming the afore-described disadvantages of low strength of the base fabric, complicated manufacturing process, high manufacturing cost, low yield and uncomfortable wearing.

To achieve the above objective, a method for making a vamp in a two dimensional manner in accordance with the present invention comprises:

a step of laying out including preparing a base fabric, laying a soft material on the base fabric;

a step of placing including placing the base fabric and the soft material in a mould assembly;

a step of pressing and heating including closing the first and second moulds to exert an external force to the soft material and the base fabric, heating the soft material and the base fabric, so that the soft material is melted and bonded to the base fabric to form a semi-final product; and

a step of demoulding including opening the mould assembly to take out the semi-final product.

The vamp made in a two dimensional manner in accordance with the present invention, comprises:

a base fabric layer including a first side and a plurality of filaments, each of the filaments including an outer surface which has an apex point, a first interval being formed between each two neighboring filaments and located at the first side; and

an adhesive layer bonded to the first side of the base fabric layer, and including a first surface, before processing, the first surface of the adhesive layer comes into contact with the apex point of the respective filaments, after processing, the adhesive layer fills the first intervals, and the first surface of the adhesive layer covers the outer surface of each of the filaments.

It can be learned from the above description that the adhesive layer is firstly laid on one side of the base fabric layer, and then melted and permeated into the intervals of the base fabric layer after being heated and pressed, so that the adhesive layer and the base fabric layer are simultaneously become a three dimensional structure to form the vamp with decorative portions.

It is to be noted that the present invention does not require the fiber spinning of the TPU or prepregging of the yarns, and the decorative members don't have to be formed in advance, all the present invention has to do is to lay the adhesive layer onto the base fabric layer, then the followed procedures can be proceeded until final products are produced, which not only simplified the manufacturing process, but also reduces the manufacturing cost.

The present invention can substantially improve the quality of the vamp and solve the conventional problem of the hollow sections caused by uncontrollable proportion of the TPU material and the TPU material deficiency, by laying adhesive layers of different thicknesses to fit the shapes of the three dimensional decorative portions of the vamp.

During the manufacturing process of the present invention, high temperature and high pressure won't change or destroy the density and strength of the base fabric layer, but instead, the adhesive layer will be melted and permeated through the micro intervals between the filaments to reinforce the strength of the base fabric layer.

Besides, the density and strength of the base fabric layer can be maintained during the manufacturing process, so that the adhesive layer when melted won't permeate through the second side of the base fabric layer, and thus the second side of the base fabric layer for contacting the wearer's skin can remain soft to improve wearing comfort.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an illustrative view of a conventional vamp in a flat two dimensional manner;

FIG. 2 is a cross sectional view of a conventional vamp, wherein the decorative member is glued to the base fabric;

FIG. 3-1 is a cross sectional view of the decorative portion of another conventional vamp;

FIG. 3-2 is a cross sectional view of the decorative portion of another conventional vamp;

FIG. 4-1 is a cross sectional view of the decorative portion of another conventional vamp;

FIG. 4-2 is a cross sectional view of the decorative portion of another conventional vamp;

FIG. 5-1 is an illustrative view illustrating the method for making a vamp in a two dimensional manner in accordance with a preferred embodiment of the present invention;

FIG. 5-2 is another illustrative view illustrating the method for making a vamp in a two dimensional manner in accordance with the preferred embodiment of the present invention;

FIG. 6 is a flow chart of the method for making a vamp in a two dimensional manner in accordance with the preferred embodiment of the present invention;

FIG. 7 is an enlarged view of a part of a vamp made by the method for making a vamp in a two dimensional manner in accordance with the preferred embodiment of the present invention; and

FIG. 8 is an enlarged view of a part of another vamp made by the method for making a vamp in a two dimensional manner in accordance with the preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

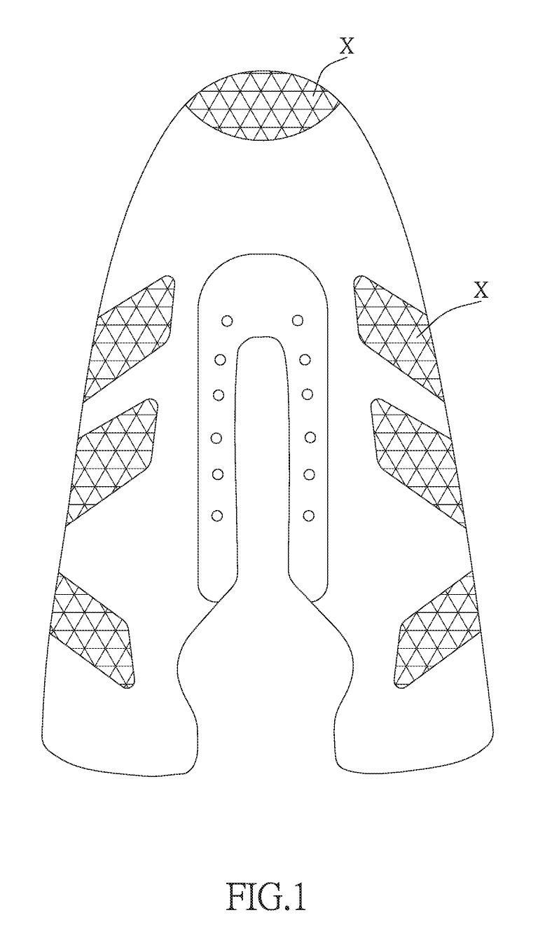

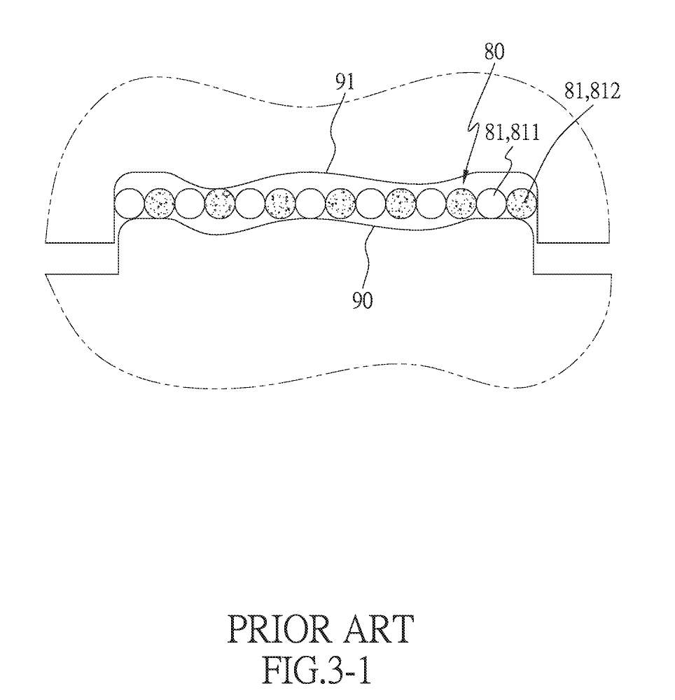

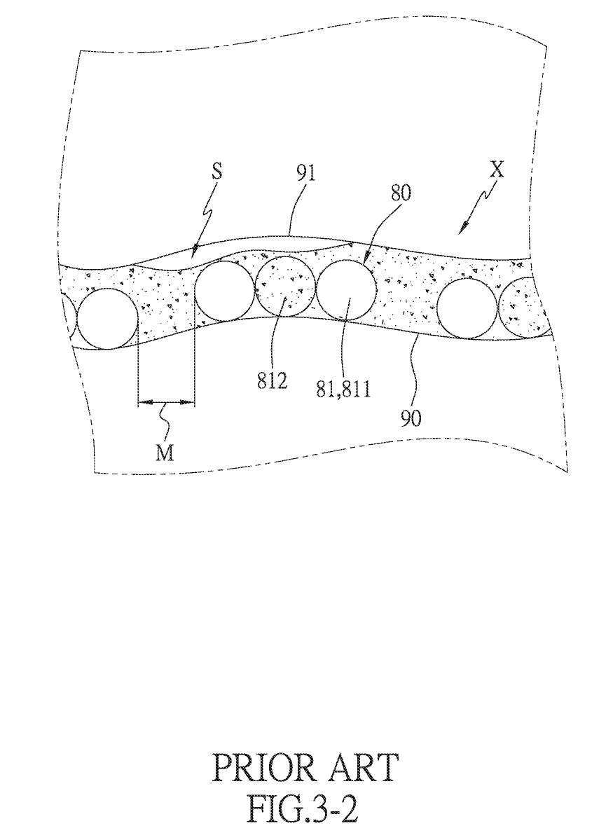

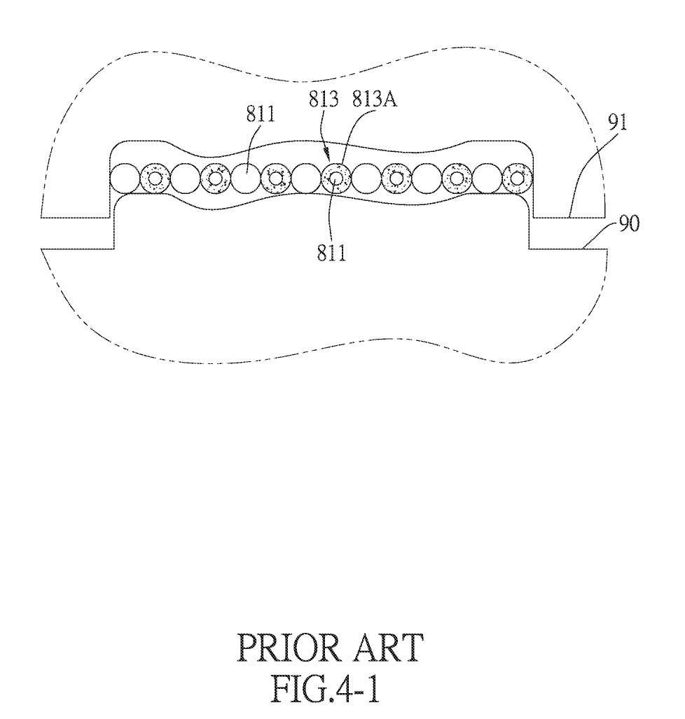

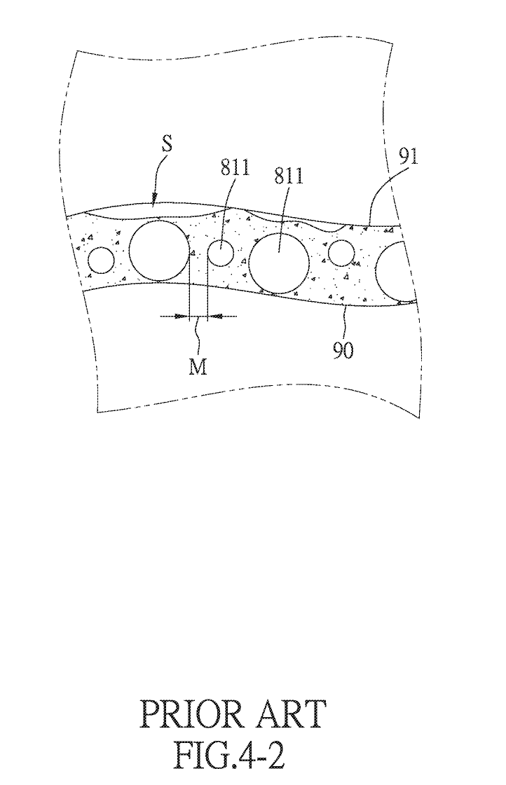

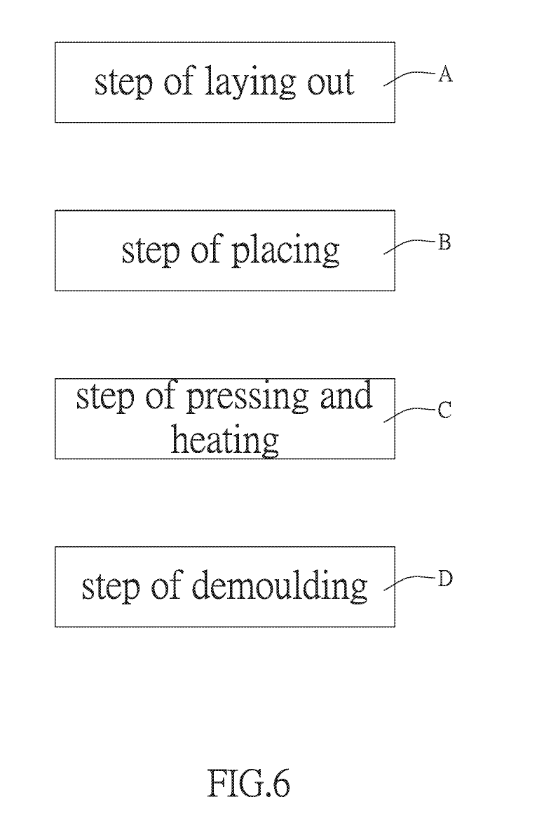

Referring to FIGS. 5-1 to 6, a method for making a vamp in a two dimensional manner in accordance with the preferred embodiment of the present invention comprises: a step A of laying out, a step B of placing, a step C of pressing and heating, and a step D of demoulding.

The step A of laying out includes: preparing a base fabric 10 which is made of natural or synthetic yarns, laying a soft material 30 on the base fabric 10, wherein the soft material 30 can be TPU (thermoplastic polyurethane) or PU (polyurethane), and more particularly, laying the soft material 30 on the base fabric 10. Preferably, the soft material 30 has a predetermined thickness d2 which can be varied to meet user's needs.

The step B of placing includes: placing the base fabric 10 and the soft material 30 in a mould assembly 20 which includes a first mould 21 and a second mould 22, more particularly, placing the base fabric 10 on the first mould 21. The base fabric 10 includes a first surface 11 facing the first mould 21, and a second surface 12 facing the soft material 30 which is laid on a second surface 12 of the base fabric 10. The second mould 22 includes a mould surface 221 and a mould cavity 222 on the mould surface 221, and the maximum distance between the second surface 12 and the mould surface 221 is defined as a predetermined distance d1.

It is to be noted that the soft material 30 has excellent ductility, tensile strength and excellent compression performance, therefore, the predetermined thickness d2 is larger than the predetermined distance d1, so that the soft material 30 has filled the mould cavity 222 of the second mould 22 before the mould assembly 20 is closed.

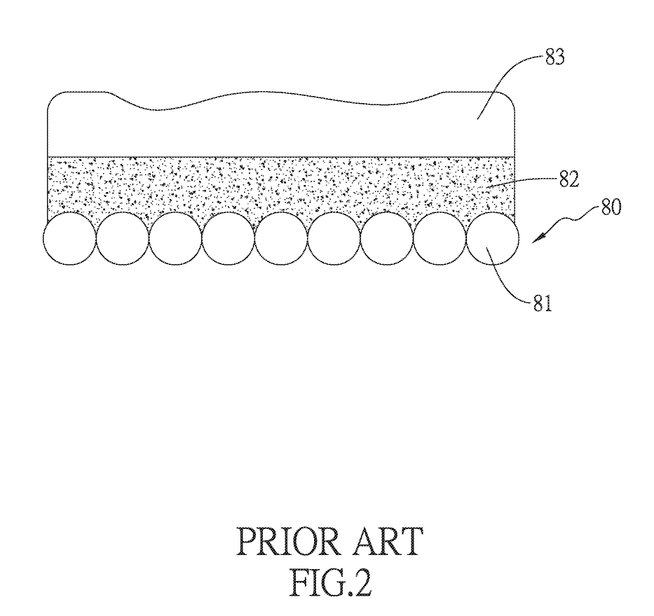

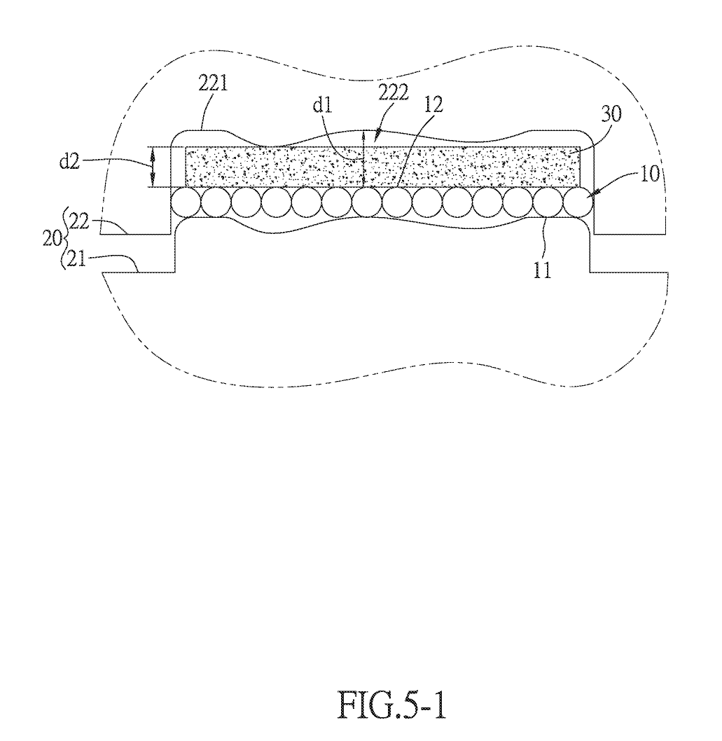

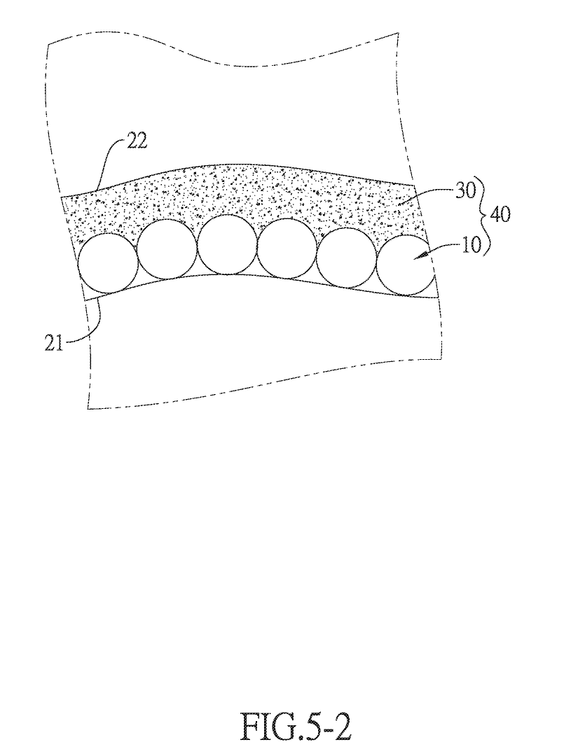

The step C of pressing and heating includes: closing the first and second moulds 21 and 22 to exert an external force to the soft material 30 and the base fabric 10, heating the soft material 30 and the base fabric 10, so that the soft material 30 is melted and bonded to the base fabric 10 to form a semi-final product 40, as shown in FIG. 5-2.

The step D of demoulding includes opening the first and second moulds 21, 22 to take out the semi-final product 40.

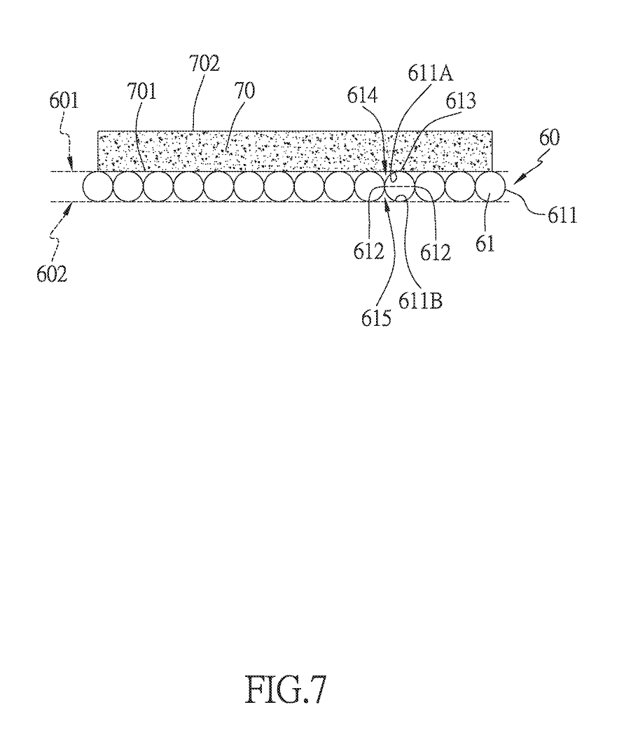

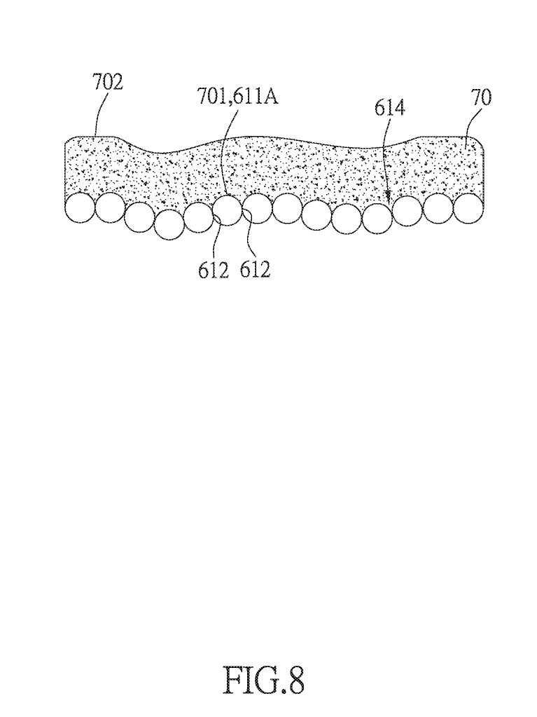

A vamp made in a two dimensional manner by the method of the present invention is shown in FIGS. 7 and 8, and comprises: a base fabric layer 60 and an adhesive layer 70.

The base fabric layer 60 includes a first side 601 and an opposite second side 602 which contacts the wearer's skin. The base fabric layer 60 includes a plurality of filaments 61 with a round cross section. Each of the filaments 61 includes an outer surface 611 which has two opposite contact portions 612 for contacting neighboring filaments 61, the two opposite contact portions 612 divide the outer surface 611 into a first outer surface 611A located on the first side 601, and a second outer surface 611B located on the second side 602, and the first outer surface 611A includes an apex point 613. A first interval 614 and a second interval 615 are formed between each two neighboring filaments 61, and are separated from each other by the contact portions 612. The first interval 614 is located at the first side 601, and the second interval 615 is located at the second side 602.

The adhesive layer 70 is disposed at the first side 601 of the base fabric layer 60, and includes a first surface 701 and a second surface 702. The adhesive layer 70 can be made of TPU or PU. Before processing, the first surface 701 of the adhesive layer 70 comes into contact with the apex point 613 of the respective filaments 61 only, and the second surface 702 of the adhesive layer 70 is a flat surface. After processing, the adhesive layer 70 fills the first interval 614, the first surface 701 of the adhesive layer 70 covers the first outer surface 611A, and the second surface 702 of the adhesive layer 70 is pressed into a three dimensional manner. The aforementioned pressing refers to the process of heating and pressing the flat vamp.

It can be learned from the above description that the adhesive layer 70 is firstly laid on one side of the base fabric layer 60, and then melted and permeated into the intervals of the base fabric layer 60 after being heated and pressed, so that the adhesive layer 70 and the base fabric layer 60 are simultaneously become a three dimensional structure to form the vamp with decorative portions.

It is to be noted that the present invention does not require the fiber spinning of the TPU or prepregging of the yarns, and the decorative members don't have to be formed in advance, all the present invention has to do is to lay the adhesive layer 70 onto the base fabric layer 60, then the followed procedures can be proceeded until final products are produced, which not only simplified the manufacturing process, but also reduces the manufacturing cost.

The present invention can substantially improve the quality of the vamp and solve the conventional problem of the hollow sections caused by uncontrollable proportion of the TPU material and the TPU material deficiency, by laying adhesive layers 70 of different thicknesses to fit the shapes of the three dimensional decorative portions of the vamp.

During the manufacturing process of the present invention, high temperature and high pressure won't change or destroy the density and strength of the base fabric layer 60, but instead, the adhesive layer 70 will be melted and permeated through the micro intervals between the filaments 61 to reinforce the strength of the base fabric layer 60.

Besides, the density and strength of the base fabric layer 60 can be maintained during the manufacturing process, so that the adhesive layer 70 when melted won't permeate through the second side 602 of the base fabric layer 60, and thus the second side 602 of the base fabric layer 60 for contacting the wearer's skin can remain soft to improve wearing comfort.

While we have shown and described various embodiments in accordance with the present invention, it is clear to those skilled in the art that further embodiments may be made without departing from the scope of the present invention.

What is claimed is:

1. A method for making a vamp in a two dimensional manner, comprising:
a step of laying out including preparing a base fabric, laying a soft material on the base fabric;
a step of placing including placing the base fabric and the soft material in a mould assembly;
a step of pressing and heating including closing the first and second moulds to exert an external force to the soft material and the base fabric, heating the soft material and the base fabric, so that the soft material is melted and bonded to the base fabric to form a semi-final product; and
a step of demoulding including opening the mould assembly to take out the semi-final product.

2. The method as claimed in claim 1, wherein the mould assembly includes a first mould and a second mould, the base fabric is laid on the first mould, the base fabric includes a first surface facing the first mould, and a second surface, and the soft material is laid on the second surface of the base fabric.

3. The method as claimed in claim 2, wherein the second mould includes a mould surface and a mould cavity on the mould surface, a maximum distance between the second surface of the base fabric and the mould surface is defined as a predetermined distance, and the soft material has a predetermined thickness which is larger than the predetermined distance.

4. The method as claimed in claim 1, wherein the base fabric is made of natural or synthetic yarns.

5. The method as claimed in claim 1, wherein the soft material is made of thermoplastic polyurethane or polyurethane.

6. A vamp made in a two dimensional manner, comprising:
a base fabric layer including a first side and a plurality of filaments, each of the filaments including an outer surface which has an apex point, a first interval being formed between each two neighboring filaments and located at the first side; and
an adhesive layer bonded to the first side of the base fabric layer, and including a first surface, before processing, the first surface of the adhesive layer comes into contact with the apex point of the respective filaments, after processing, the adhesive layer fills the first intervals, and the first surface of the adhesive layer covers the outer surface of each of the filaments.

7. The vamp as claimed in claim 6, wherein the adhesive layer is made of thermoplastic polyurethane or polyurethane.

8. The vamp as claimed in claim 6, wherein the base fabric layer includes a second side opposite the first side, the outer surface of each of the filaments includes two opposite contact portions for contacting neighboring filaments, the two opposite contact portions divide the outer surface into a first outer surface located on the first side, and a second outer surface located on the second side, a second interval is formed between each two neighboring filaments and is separated from the first interval by the contact portions, after processing, the first surface of the adhesive layer covers the first outer surface.

9. The vamp as claimed in claim 6, wherein the adhesive layer further includes a second surface, and before processing, the second surface of the adhesive layer is a flat surface.
